(19) United States
(12) Patent Application Publication
(10) Pub. No.: US 2009/0210348 A1
(43) Pub. Date: Aug. 20, 2009

(54) System and method for electronic commerce

(76) Inventor: Steffan Gottfried Klein, Victoria (AU)

Correspondence Address: Pearl Cohen Zedek Latzer, LLP, 1500 Broadway, 12th Floor, New York, NY, 10036, US

(21) Appl. No.: 10/588,275

(22) PCT Filed: Jan. 31, 2005
(86) PCT No.: PCT/AU05/00113

§ 371 Date: Oct. 22, 2008

(30) Foreign Application Priority Data
Feb. 4, 2004 (AU) 2004900527

(51) Int. Cl. H04L 9/00; G06Q 30/00

(52) U.S. Cl. 705/75; 705/26

(57) ABSTRACT

A method of identifying altered order critical data in a system for conducting electronic commerce over a public data network in which orders are placed by a customer using a computer. The method includes the step of transmitting an electronic order of the customer over the public data network from the customer computer to a validation server. The validation server validates order critical data included in the order by executing the steps of verifying the order critical data, and generating an indication of the validity or otherwise of the order critical data. The method enables, for example, orders generated by untrusted devices, such as a customer computer, to be verified by a trusted validation server thereby improving the security of electronic commerce systems employing client-side ordering.

### FIELD OF THE INVENTION

The present invention relates to electronic commerce systems, and in particular to a system, method and associated apparatus for identifying and preventing fraud in electronic commerce systems in which orders are placed over an insecure network.

### BACKGROUND OF THE INVENTION

Today's computer networking environments, such as the Internet, offer an unprecedented medium for facilitating the promotion and purchase of goods and services online. Accordingly, in recent years there has been massive growth in so-called electronic commerce (sometimes abbreviated to “e-commerce”). The provision of “virtual stores” or “electronic shops” enables customers to research and purchase goods and services from merchants and other providers from the comfort and privacy of the home or office without incurring the time or expense required to visit the merchant's place of business. In particular, online shopping enables consumers to procure goods and services from providers located overseas, or in otherwise geographically distant locations, from whom it may otherwise be impractical to purchase products or services.

From the merchant's perspective, too, there are significant benefits to be derived from doing business online. For example, it is now possible to conduct business entirely over the Internet, providing a virtual shopfront and taking all orders electronically, thus avoiding the need to maintain any physical retail premises. Not only does this save on the more apparent costs associated with a physical retail outlet, such as rent and staffing, but conducting a wholly electronic business may provide a merchant with greater control over inventory and further cost savings associated with running a more completely automated enterprise.

Even if it is considered desirable to maintain traditional retail premises in order to cater for more conventional retail trade, the provision of a parallel online service enables a merchant to access a much larger, and potentially global, market. Furthermore, it is increasingly becoming necessary for merchants to provide at least a basic level of online service in order to compete with aggressive online traders who threaten to erode more traditional markets.

E-commerce “shops” are software programs, or collections of software components, that implement an interface presented on a customer's computer screen that enables products or services and their details to be displayed and orders to be generated and sent to the merchant over the Internet. In the most general architecture for such an e-commerce system, the merchant operates a server, or a service provider operates a server on the merchant's behalf, to which the customer connects using a computer via the Internet. The customer's computer thus acts as a client to the service provided by the merchant server. At present, it is usual that the server is a World Wide Web server, and the customer is thus able to access the electronic shop using a standard Web browser.

Within this general architecture, e-commerce shops may be divided into two main types—those that employ primarily server-side implementations of the software programs, and those that employ substantial client-side software to implement the online shop.

In server-side solutions, the computer programs required and all information used by the programs are stored on the server and remain on the server. In this case, it is usual that the server stores and/or constructs web pages including the details of the products and/or services on sale and sends them to the client (i.e. customer) computer upon request. To generate an order, the customer completes the required details in Web forms provided by the server, and sends them back for processing at the server-side. Accordingly, processing of the order is carried out by the server, which is the characteristic quality of a server-side solution.

The primary advantage of a server-side implementation is that customers can view and interact with the programs and the information, but they are prevented from modifying them in any way. Since customers are not provided with write-access to the server, it is very difficult, if not impossible, for customers to fraudulently change critical data, such as pricing information, to obtain products at a lower price.

The disadvantage of a server-side implementation is that all programs must be executed on the server and must interact with information stored on the server. For a busy online store this may require a large amount of processing capability, as the server may be required to process the requests of many customers. The scalability of server-side systems to handle increasing numbers of customers is thus an issue, and, indeed, large online stores require server “farms” consisting of many individual server computers along with complex load-balancing systems and inter-server communication protocols to distribute the workload effectively amongst the servers.

In client-side solutions, on the other hand, at least some of the program components and information required are downloaded to the customer's client computer, and are executed on the client.

Client-side solutions therefore reduce the load on the server by transferring part, or all, of the processing load associated with a customer query and/or order to the client computer. The advantage of this approach from the customer's perspective is that any transaction is effected more rapidly and there is a faster response to user actions. This provides a more satisfying interactive experience than may be the case when such actions result in requests to a remote server, following which the customer must await a response. From the merchant's perspective, the server processing requirements may be substantially reduced, as all programs are executed on the client side. Furthermore, in the extreme case it is possible to produce an e-commerce shop that is able to function independently of an Internet server—a client side electronic shop can be distributed, for example, on a CDROM and a customer can in principle create an order even without being connected to the Internet.

However, client-side solutions have a significant disadvantage in that since the programs used to generate an order are transferred to the client computer, which is outside the control of the merchant or service provider, they are untrusted. In particular it is possible for a person with sufficient skill in computer programming to gain access to the programs and/or data of the client-side electronic shop and fraudulently modify data and programs in order to gain access to products at a lower price. This is unavoidable because all programs must be executable by the Internet browser on the customer's computer.

Any data could be affected by this, such as tax, discounts, product prices, and shipping charges, as well as price subtotals and total price to be paid as calculated by the electronic shop programs.

A fraudulent customer could, for example, change a price of a product to zero, negate calculated tax or shipping charges or set a discount to 100% to save money. Such data is therefore critical to the integrity of an order, since alteration has the potential to result in loss of income to the merchant. This kind of data will therefore be referred to hereafter as “order critical data” or “endangered data”.

Endangered data cannot be sufficiently protected on the client side. Encryption can be used to protect the data in transit between the server and the client, but encryption is only effective when there is mutual trust between the sender and recipient of data. To allow any calculations on the client side, the data would have to be decrypted on the client side, and thus the program code for performing the decryption, along with any necessary decryption keys, must be available on the client-side. However, as has already been explained, the client cannot be considered trustworthy by the server, since any sufficiently skilled programmer can gain access to the decryption function and keys, giving full access to the endangered data. Storing a decryption key or a special programming function on a remote server, to be called by the client-side programs as required, does not solve the problem, since such a call must be initiated by the client and could therefore be intercepted, giving the programmer access to the key or function, and therefore to the endangered data.

Accordingly, there is a need for an electronic commerce system, method, and associated apparatus, that provide at least some of the above described benefits of a client-side solution while mitigating the problems associated with the generation of orders in an untrusted environment.

### SUMMARY OF THE INVENTION

In one aspect the invention provides a method of identifying altered order critical data in a system for conducting electronic commerce over a public data network in which orders are placed by a customer using a computer, the method including the steps of:

transmitting an electronic order of the customer over the public data network from the customer computer to a validation server that validates order critical data included in the order, the validation server executing the steps of:

verifying said order critical data; and

generating an indication of the validity or otherwise of the order critical data.

In another aspect the invention provides a method of operating a validation server in a system for conducting electronic commerce over a public data network in which orders are placed by a customer using a computer, the method including the steps of:

receiving from the customer computer over the public data network an electronic order of the customer, said electronic order including order critical data;

verifying said order critical data; and

generating an indication of the validity or otherwise of the order critical data.

In yet another aspect, the invention provides a method of a customer placing an order in a system for conducting electronic commerce over a public data network whereby alterations to order critical data are identified, the method including the steps of:

generating an electronic order including order critical data; and

transmitting the electronic order over the public data network to a validation server that verifies said order critical data, and generates an indication of the validity or otherwise of the order critical data. Preferably, the indication of whether the order critical data is valid or otherwise includes an indication that the order critical data has been altered in the event that the order critical data is invalid. However, said indication may additionally or alternatively include an indication that the order critical data has not been altered in the event that the order critical data is valid.

Accordingly, if the customer attempts to alter any of the critical data in the electronic order, the validation server will identify that the order has been altered and will generate an indication that altered data has been detected. Advantageously, this indication may subsequently be used to determine whether or not a merchant is to fulfil the order, thus providing enhanced confidence that accepted orders include details that correspond with a published offer, and have not, for example, been fraudulently altered by the customer in order to obtain a discount.

Accordingly, in the event that the order critical data is valid, the validation server may in some embodiments of the invention transmit the electronic order to at least one relevant merchant for fulfilment. Conversely, in the event that the order critical data in invalid, the validation server may reject the electronic order.

It will be appreciated by those skilled in the art that where the word “merchant” is used in this specification, the term encompasses not only a person responsible for the fulfilment of orders, but also an agent or an automated system acting on behalf of such a person.

In some embodiments, the method further includes the validation server executing the steps of:

generating a report including information indicating whether or not said order critical data is valid; and

transmitting the report to one or more relevant merchants receiving the electronic order thus enabling said merchants to identify if order critical data in the electronic order is valid.

A merchant receiving the report is thereby able to fulfil electronic orders received from a customer computer with enhanced confidence that the order details correspond with a published offer, so long as a favourable report has been issued by the validation server.

The report may be a human readable report, such as a plain text document. Alternatively, the report may be a machine readable report suitable for automated processing.

In alternative embodiments, the method includes the validation server, on the basis of said indication, if the order critical data is invalid executing the step of rejecting the electronic order, and otherwise executing the step of transmitting the electronic order to relevant merchants for fulfilment.

Advantageously, in such embodiments a merchant is not required to receive or process any order that has not been successfully validated by the validation server.

Preferably, orders are placed by the customer using client-side software including one or more program components adapted for execution on the customers computer.

Preferably, the public data network is the Internet.

The electronic order may include critical data relating to one or more products that the customer wishes to purchase, and may further include customer details such as identifying information of the customer, customer location and payment information such as credit card details. The electronic order may also include data generated by the customer computer, such as a total price of the order including all selected products, applicable shipping costs, taxes and discounts.

The step of verifying may include recalculation of the total order price based on the customer details, location and selected products. Advantageously, this ensures that the order cannot be fraudulently altered by changing the total price only, since this price has been calculated at the customer computer and may not be considered trustworthy at the validation server.

The method may also include the steps of:

providing a commerce server for serving product details;

the customer downloading product details from the commerce server to the customer computer over the public data network; and

generating the electronic order using the product details downloaded from the commerce server.

Accordingly, up-to-date product details may be maintained on the commerce server to provide an “electronic shop” which ensures that the customer is provided with current product information upon each use of the system.

Preferably the one or more program components are downloaded to the customer computer from the commerce server. Accordingly, upon each use of the system the customer will always be provided automatically with the most recent version, of the client-side software as stored on the server, thus avoiding the need for an electronic shop operator to distribute software updates and for the customer to take any special steps to install such updates.

The product details may be included within the one or more program components, in which case current product details will automatically be available to the customer upon download of the most recent software updates. Alternatively, the product details may be served separately by the commerce server, in which case they will be downloaded as required for processing by the client-side software.

Preferably the commerce server is an Internet web server. The product details and the one or more program components may be included in web pages that are downloaded to the customer computer using an Internet browser application executing on the customer computer. The one or more program components are preferably integrated into the web pages by using a client-side web programming language such as JavaScript or Dynamic HTML or plug-ins, such as Java applets or ActiveX controls, that execute within the environment of the Internet browser application.

As an alternative to providing a commerce server, the complete electronic shop may be distributed to the customer in another form readable using the customer computer, such as on a CDROM or other medium. Advantageously, this enables the customer to select products for purchase and create an electronic order without the need to connect to a remote commerce server and download program components and/or product details over the public data network. This alternative may therefore provide the customer with a more rapidly responsive and interactive electronic shopping experience, especially if the customer's connection to the data network is slow.

In one preferred embodiment of the method including the step of the customer downloading product details from the commerce server to the customer computer over the public data network, the order critical data is included in said product details and is digitally signed with a secret key, and the step of transmitting includes transmitting the digital signature along with the electronic order, and the step of verifying includes the validation server verifying that the digital signature corresponds with the order critical data.

The order critical data may include, for example, a product identifier and a price. Accordingly, any attempt made by the customer to fraudulently alter the price of a product in an order transmitted to the validation server will result in a failure of the digital signature to correspond with the altered order critical data, and the consequent generation of an adverse fraud report.

In another embodiment, the method further includes the step of associating the validation server with a database including copies of the order critical data, and the step of verifying includes the validation server comparing the order critical data included in the order with the corresponding copy held within the database. Since the customer is unable to gain access to the contents of the database or change any entries therein, any attempt to submit a fraudulent order containing altered order critical data, such as, for example, a reduced price for a product, will be detected by the validation server which will generate an adverse fraud report.

In a variation of this embodiment, the step of transmitting the electronic order includes transmitting an order including incomplete order critical data, and the step of verifying includes the validation server completing the order critical data using the corresponding copy held within the database. For example, the order critical data may include a product identifier and a price, and the transmitted order may include the product identifier but omit the price, which may then be provided by the validation server from the database, so as to produce a final order that is guaranteed to be valid.

In yet another alternative embodiment of the method including the step of the customer downloading product details from the commerce server to the customer computer over the public data network, the order critical data is duplicated in said product details including a first copy in unencrypted form and a second copy encrypted using a secret key, and the step of transmitting includes transmitting the encrypted copy of the order critical data along with the electronic order, and the step of verifying includes the validation server verifying that the encrypted data corresponds with the unencrypted order critical data in the electronic order.

The validation server may be provided with a decryption key for decrypting the encrypted data such that it is able to compare the unencrypted order critical data with the decrypted order critical data in order to verify that the encrypted data corresponds with the unencrypted data. The decryption key may be the same as the secret key used to encrypt the second copy of the order critical data. Alternatively, the validation server may use the secret key to encrypt the unencrypted order critical data such that it is able to compare its own encrypted copy of the data with the received encrypted data. Whichever alternative is used, if there is a mismatch an adverse fraud report may be generated.

Advantageously, so long as the customer does not know the secret key it is impossible for the customer to generate an encrypted copy of fraudulently altered critical data for transmission to the validation server and, accordingly, any attempt made by the customer to fraudulently alter, for example, the price of a product in an order transmitted to the validation server will result in a failure of the encrypted and unencrypted order critical data to correspond with one another, resulting in the generation of an adverse report.

In still another alternative embodiment of the method including the step of the customer downloading product details from the commerce server to the customer computer over the public data network, the step of verifying includes the validation server downloading relevant product details from the commerce server and comparing order critical data in the downloaded product details with the corresponding data in the received electronic order. Since the customer is unable to alter the information held within the commerce server, any attempt to submit a fraudulent order containing altered order critical data, such as, for example, a reduced price for a product, will be detected by the validation server which will generate an adverse report.

In a variation of this embodiment, the step of transmitting the electronic order includes transmitting an order including incomplete order critical data, and the step of verifying includes the validation server completing the order critical data using the corresponding copy downloaded from the commerce server. For example, the order critical data may include a product identifier and a price, and the transmitted order may include the product identifier but omit the price, which may then be downloaded by the validation server from the commerce server, so as to produce a final order that is guaranteed to be valid.

In another aspect the invention provides a validation server for identifying altered order critical data in a system for conducting electronic commerce over a public data network in which orders are placed by a customer using a computer, the validation server including:

receiving means for receiving an electronic order of the customer transmitted over the public data network from the customer computer, said electronic order including order critical data;

verifying means for verifying said order critical data; and

indicating means for generating an indication of whether the order critical data is valid or otherwise, to enable altered order critical data to be identified.

In embodiments of the validation server, the receiving means may include suitable interface hardware for interfacing to the public data network, and may further include one or more software components executing on a central processing unit, the software components including instructions to effect processing of communications protocols and of the electronic order. The verifying means may include one or more software components executing on a central processing unit including instructions to effect processing steps for verifying that the order critical data is valid, as required by the particular embodiment of the invention. The indicating means may include one or more software components executing on a central processing unit including instructions to effect the generation of an indication that the order critical data has been altered.

In some embodiments, the validation server further includes:

report generating means for generating, on the basis of the indication generated by said indicating means, a report including information indicating whether or not said order critical data in the electronic order is valid.

The report generating means may include one or more software components executing on a central processing unit including instructions to effect the generation of the report.

The report may subsequently be transmitted to relevant merchants thus enabling the merchants to identify if order critical data of the customer electronic order is valid.

In alternative embodiments, the validation server includes rejection means for rejecting the electronic order if said indicating means indicates that the critical data is invalid. Rejected orders may thus not be transmitted to relevant merchants for fulfilment.

The rejection means may include one or more software components executing on a central processing unit including instructions to determine if the indicating means indicates that the critical data is invalid, and if so to effect rejection of the electronic order.

In one preferred embodiment of the validation server, the receiving means is adapted to receive a digital signature along with the electronic order, the digital signature being the result of digitally signing the order critical data with a secret key, and the verifying means includes means for verifying that the digital signature corresponds with the order critical data.

In another embodiment, the validation server is associated with a database that includes copies of the order critical data, and the verifying means includes means for comparing the order critical data included in the order with the corresponding copy held within the database.

In a variation of this embodiment, the received order includes incomplete order critical data, and the verifying means is adapted to complete the order critical data using the corresponding copy held within the database.

In yet another alternative embodiment of the validation server, the receiving means is adapted to receive duplicated order critical data including a first copy in unencrypted form and a second copy encrypted using a secret key and the verifying means includes means for verifying that the encrypted data corresponds with the unencrypted order critical data in the electronic order.

In still another alternative embodiment, the validation server includes means for connecting to a commerce server and for downloading a copy of product details including order critical data from said commerce server, and the verifying means includes means for comparing the downloaded order critical data with the corresponding data in the received electronic order.

In a variation of this embodiment, the received order includes incomplete order critical data, and the verifying means is adapted to complete the order critical data using the corresponding copy downloaded from the commerce server.

In a further aspect the invention provides a client-side software product for use in a customer computer in a system for conducting electronic commerce over a public data network where orders are placed by a customer using a computer, the client-side software product including:

computer instruction code for generating an electronic order of the customer including order critical data; and

computer instruction code for effecting transmission of the electronic order over the public data network from the customer computer to a validation server that verifies said order critical data and generates an indication of the validity or otherwise of the order critical data.

Preferably, the client-side software product also includes computer instruction code enabling connection with a commerce server and downloading product details including relevant order critical data from the commerce server. The computer instruction code preferably enables generation of an electronic order using the downloaded product details. Alternatively, the client-side software product may include the product details, and also include computer instruction code adapted to generate the electronic order using the included product details.

In one preferred embodiment, the computer instruction code enabling connection with the commerce server is further adapted to enable downloading of a digital signature along with the product details, the digital signature being the result of digitally signing the order critical data with a secret key, and the computer instruction code for effecting transmission of the electronic order includes instruction code for effecting transmission of the digital signature over the public data network along with the electronic order.

In some embodiments, the computer instruction code for effecting transmission is adapted to effect transmission of incomplete order critical data such that the validation server is able to complete the order critical data after receiving the electronic order.

In yet another alternative embodiment, the computer instruction code enabling connection with the commerce server is further adapted to enable downloading of duplicated order critical data including a first copy in unencrypted form and a second copy encrypted using a secret key, and the computer instruction code for effecting transmission of the electronic order includes instruction code for effecting transmission of the encrypted order critical data over the public data network along with the electronic order.

In yet another aspect the invention provides a system for conducting electronic commerce over a public data network including a client-side software product and a validation server in accordance with the present invention as previously described.

It will be appreciated from the above summary that the essence of the invention lies in the appreciation that in a client-side electronic shop implementation the customer can only change the programs and data on the customer computer and thus only has the ability to alter his own order. The customer is unable to alter order critical data securely stored elsewhere, such as on the commerce server or in a remote database. The present inventor has accordingly realised that, while server-side solutions rely on the fundamental security of the data held on the server and thus generate orders that are implicitly valid, in a client-side shopping solution, the problem of fraud prevention may be effectively addressed as part of the ordering process itself.

### BRIEF DESCRIPTION OF THE DRAWINGS

Further benefits and advantages of the present invention will become apparent in the following description of preferred embodiments of the invention, which should not, however, be considered to limit the scope of the invention as defined in any of the preceding statements or the claims appended hereto. Preferred embodiments are described with reference to the accompanying drawings in which like numerals represent like elements, and in which:

FIG. 1 is a diagram illustrating schematically an embodiment of a system and method according to the invention, in which a digital signature is used to validate critical data in a customer order;

FIG. 2 is a diagram illustrating schematically another embodiment of a system and method according to the invention, in which data stored in a secure database is used to validate critical data in a customer order;

FIG. 3 is a diagram illustrating schematically a further embodiment of a system and method according to the invention, in which data stored in a secure database is used to complete critical data in a customer order;

FIG. 4 is a diagram illustrating schematically yet another embodiment of a system and method according to the invention, in which encrypted duplicate data is used to validate critical data in a customer order;

FIG. 5 is a diagram illustrating schematically still another embodiment of a system and method according to the invention, in which critical data in a customer order is validated by comparison with original data retrieved from a commerce server;

FIG. 6 is a flowchart illustrating a method of identifying altered order critical data according to a preferred embodiment of the invention;

FIG. 7 shows a flowchart illustrating an alternative method of identifying altered order critical data; and

FIGS. 8 to 12 are flow charts illustrating different methods of validating order critical data in a customer order according to preferred embodiments of the invention.

### DESCRIPTION OF PREFERRED EMBODIMENTS

In preferred embodiments of the invention, an automated procedure is provided to enable a merchant to create an e-commerce shop. The merchant first enters the required product data, such as product names, descriptions and prices, into a product database. A computer program then combines the product data with the required programming functions and programs such as a shopping cart and generates web pages containing the product data, the programs and program functions. These data and programs form the “electronic shop”, which is subsequently published to the Internet so that it can be accessed by customers from their own computers using a web browser.

The automated generation procedure simplifies creation of the shop by the merchant, who is thereby required to enter only product data and, accordingly, the merchant does not require any knowledge of web design or programming. However, it will be appreciated by those skilled in the art that differing levels of automation may be provided and, for example, the web pages may be created or modified using manual editing methods in order to create a more highly customised electronic shop.

Depending upon the operating environment and merchant requirements, the resulting electronic shop may take one of three main forms:
1. A server-generated shop, in which the electronic shop is generated on a server operated by a third party providing this service to the merchant. The shop, consisting of web pages containing programs and product data, is published to the Internet by the server. The order critical data is thus included in the shop, and is also stored in the product database on the server.
2. A merchant-generated shop, in which the electronic shop is generated on a computer maintained and operated by the merchant. The shop, consisting of web pages containing programs and product data, is published to the Internet by the merchant. The order critical data is thus included in the shop, and is also stored in the product database on the merchant computer.
3. A shop consisting of web pages only, in which there is no separate product database, or the product database is not stored on the computer serving the web pages. For example, the web pages may have been built manually, without the use of a product database and automated generation process. In this case, the only place in which the order critical data is stored may be the web pages themselves.

Preferred embodiments of the invention accordingly provide validation solutions that are applicable to these different forms of online shop.

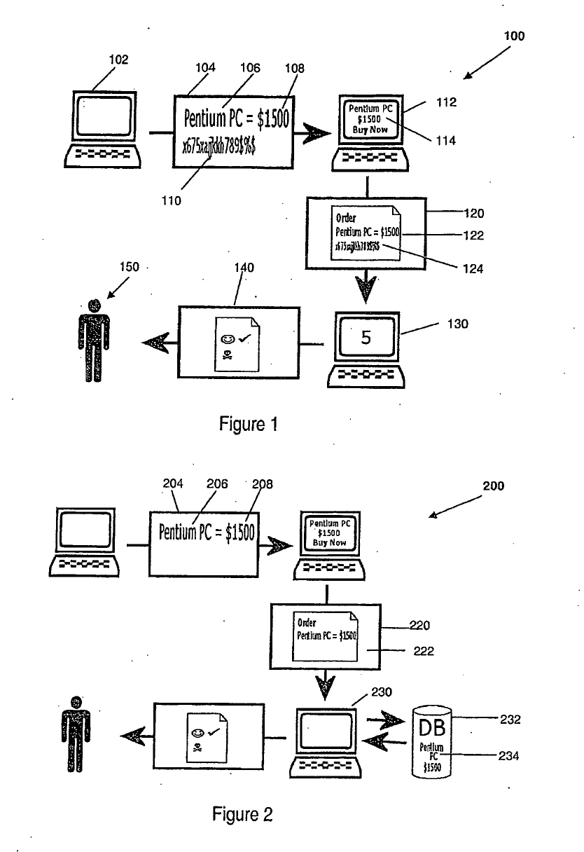

A first embodiment 100 of a system and method according to the invention is illustrated schematically in FIG. 1. A commerce server 102 serves web pages 104 containing the shop and product data to a customer computer 112. The product data includes order critical data such as product identifiers 106 and associated price 108. The order critical data is digitally signed using a secret key and the digital signature 110 is included in the web pages. The client-side electronic shop runs on the customer computer 112, presenting a user interface 114 that enables the customer to search, browse and select products for purchase.

The client-side electronic shop program displays the order-critical data, and uses this data to calculate the total cost of products selected by the customer, including relevant taxes, shipping costs, and other additional charges and/or discounts, and to generate an electronic order 120. The order 120 contains the order critical data 122 at least for the products ordered and the corresponding digital signatures 124, as well as any customer details required, such as customer identification, location and purchase details, for example a credit card number.

The order 120 is passed on to a trusted validation server 130 which knows the secret key used to sign the order critical data. By comparing the order critical data with its signature the validation server is able to determine if any of the data have been fraudulently altered. Since the secret key is not known at the customer computer 112, it is not possible for the customer to generate a valid replacement signature corresponding to altered order critical data. The validation server 130 may also recalculate the total order value using the verified data in order to validate the totals.

The validation server 130 then generates a fraud report 140, and makes it available to the merchant 150. If the order critical data and totals are valid, then a favourable fraud report is generated, and the merchant 150 will be able to fulfil the order, confident that the customer has not made fraudulent changes to critical data. However, if any of the data is found to be invalid, then an adverse fraud report will be generated, alerting the merchant to possible fraud.

The embodiment 100 is particularly preferred for e-commerce systems in which the electronic shop is automatically generated, since the digital signatures can easily be generated and included in the shop web pages at the time of generation. However, this embodiment does not require a separate copy of the product data to be available online to the validation server 130, since all information required to validate an order is available within the shop pages.

It will be appreciated by those skilled in the art that, although in FIG. 1 the commerce server 102 and validation server 130 are shown as separate computers, the figure shows a schematic representation of the invention and these two functions may in fact be carried out by the same computer.

A second embodiment 200 of a system and method according to the invention is illustrated schematically in FIG. 2. A commerce server 102 serves web pages 204 containing the shop and product data to a customer computer 112. The product data includes order critical data such as product identifiers 206 and associated price 208. In contrast with the embodiment 100, it will be noted that in embodiment 200 there is no digital signature included in the web pages. The client-side electronic shop runs on the customer computer 112, presenting a user interface 114 that enables the customer to search, browse and select products for purchase.

The client-side electronic shop program displays the order-critical data, and uses this data to calculate the total cost of products selected by the customer, including relevant taxes, shipping costs, and other additional charges and/or discounts, and to generate an electronic order 220. The order 220 contains the order critical data 222 at least for the products ordered, as well as any customer details required, such as customer identification, location and purchase details, for example a credit card number.

The order 220 is passed on to a trusted validation server 230. There is associated with the validation server 230 a database 232 which includes the order critical data 234 for the products. By comparing the order critical data in the order 220 with the corresponding data 234 in the database 232 the validation server is able to determine if any of the data have been fraudulently altered. Since the database 232 is not accessible from the customer computer 112, it is not possible for the customer to alter the contents of the database. The validation server 230 may also recalculate the total order value using the verified data in order to validate the totals.

The validation server 230 then generates a fraud report 140, and makes it available to the merchant 150. If the order critical data and totals are valid, then a favourable fraud report is generated, and the merchant 150 will be able to fulfil the order, confident that the customer has not made fraudulent changes to critical data. However, if any of the data is found to be invalid, then an adverse fraud report will be generated, alerting the merchant to possible fraud.

The embodiment 200 is particularly preferred for e-commerce systems in which a copy of product data is stored separately from the shop web pages, such as in a product database from which the shop pages are generated, since the additional copy of the product data can be used as, or in the generation of, the database 232.

Again, it will be appreciated by those skilled in the art that, although in FIG. 2 the commerce server 102 and validation server 230 are shown as separate computers, the figure shows a schematic representation of the invention and these two functions may in fact be carried out by the same computer.

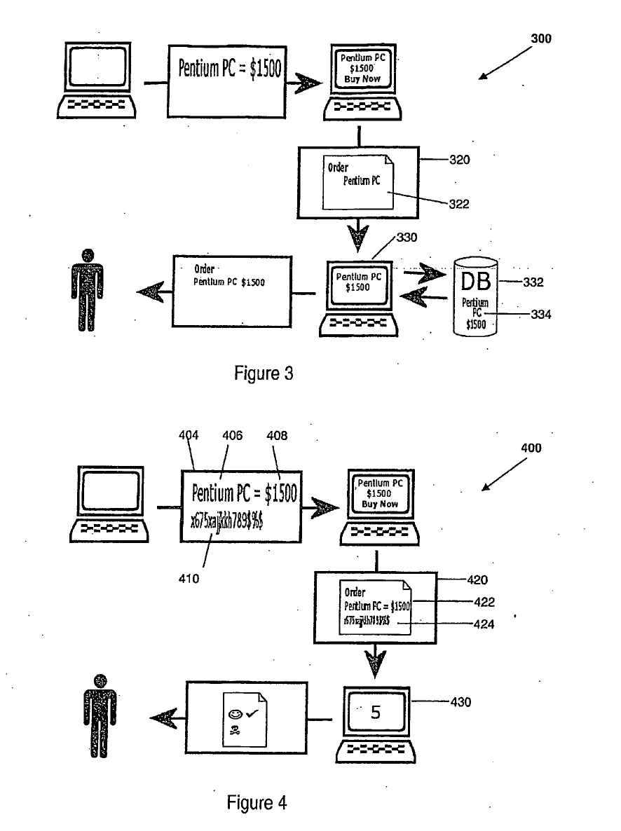

A third embodiment 300 of a system and method according to the invention is illustrated schematically in FIG. 3, which is a variation of the embodiment 200. Again, a commerce server serves web pages containing the shop and product data to a customer computer, at which selections are made and an order 320 generated. However, in the embodiment 300, the order 320 includes only product identifying data 322. The remaining order critical data is not included in the order 320.

The order 320 is passed on to a trusted validation server 330, which is again associated with a database 332 which includes the order critical data 334 for the products. By completing the order critical data in the order 320 with the corresponding data 334 in the database 332 the validation server is able to create a completed order that cannot be fraudulently altered by the customer. Since the database 332 is not accessible from the customer computer 112, it is not possible for the customer to alter the contents of the database. The validation server 330 may also recalculate the total order value using the verified data in order to validate the totals.

The validation server 230 then generates a fraud report 140, and makes it available to the merchant 150. Once again, it will be appreciated that the functions of the commerce server and the validation server may be carried out by the same computer.

A fourth embodiment 400 of a system and method according to the invention is illustrated schematically in FIG. 4. A commerce server 102 serves web pages 404 containing the shop and product data to a customer computer 112. The product data includes order critical data such as product identifiers 406 and associated price 408. The order critical data is also duplicated, the second copy 410 being encrypted using a secret key.

The order 420 generated by the client-side electronic shop program contains the order critical data 422 at least for the products ordered and the corresponding encrypted duplicates 424. The order 420 is passed on to a trusted validation server 430 which knows the secret key used to encrypt the order critical data. The validation server 430 may thus either decrypt the encrypted copies, or encrypt the unencrypted copies of the critical data in the order, and compare the results in order to determine if any of the data have been fraudulently altered. Since the secret key is not known at the customer computer 112, it is not possible for the customer to generate a valid encrypted duplicate corresponding to altered order critical data.

The validation server 430 then generates the fraud report 140, and makes it available to the merchant 150. Again, the functions of the commerce and validation servers may be carried out by the same computer.

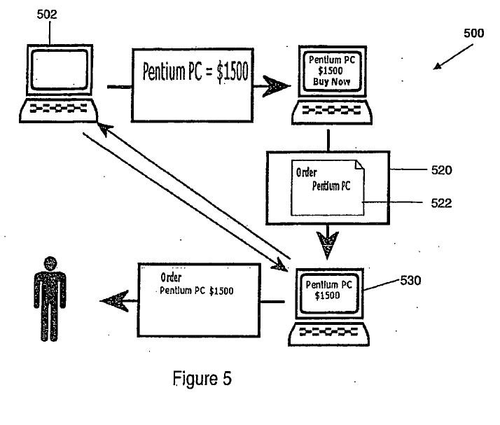

A fifth embodiment 500 of a system and method according to the invention is illustrated schematically in FIG. 5. Again, a commerce server 502 serves web pages containing the shop and product data to a customer computer, at which selections are made and an order 520 generated. As shown in FIG. 5, the order 520 includes only product identifying data 522, however it will be understood that the remaining order critical data could also be included in the order 520.

The order 520 is passed on to a trusted validation server 530. The validation server then retrieves the original product information, including the order critical data, from the commerce server 502. The validation server 530 is thus able to complete the order critical data in the order 520 with the corresponding data retrieved from the commerce server 502. Alternatively, if the critical data was included in the order 520, the validation server is able to verify that it has not been altered by comparing it with the copy retrieved from the commerce server 502. Since the web pages stored on the commerce server 502 are not accessible for writing from the customer computer 112, it is not possible for the customer to alter the commerce server copy of the critical data. The validation server 530 may also recalculate the total order value using the verified data in order to validate the totals.

The validation server 530 then generates a fraud report and/or a completed order, and makes it available to the merchant 150. Once again, it will be appreciated that the functions of the commerce server and the validation server may be carried out by the same computer.

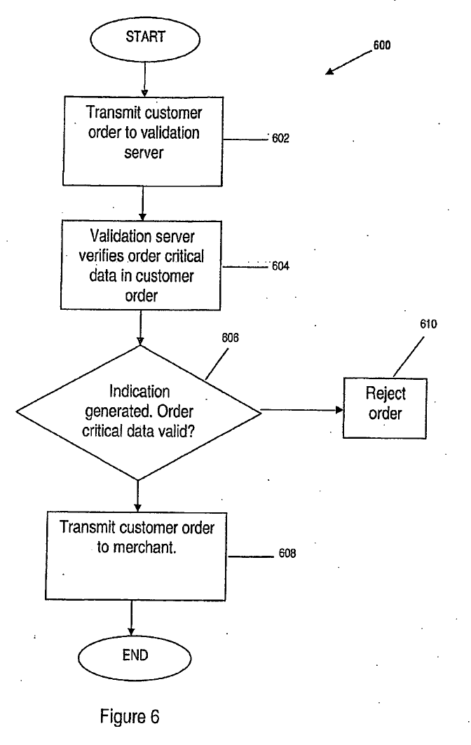

FIGS. 6 to 12 are flowcharts summarising the preferred methods of identifying altered order critical data described previously with reference to FIGS. 1 to 5. In FIG. 6, a flowchart of a method 600 of identifying altered order critical data is depicted in accordance with one embodiment of the invention. In step 602 a customer order is transmitted to a validation server. The validation server verifies the order critical data in the customer order in step 604. At step 606 an indication is generated of the outcome of the verification step 604, which is used to determine whether or not the order should be rejected at step 610, in the case of invalid order critical data, or transmitted to a relevant merchant at step 608, in the case of valid order critical data.

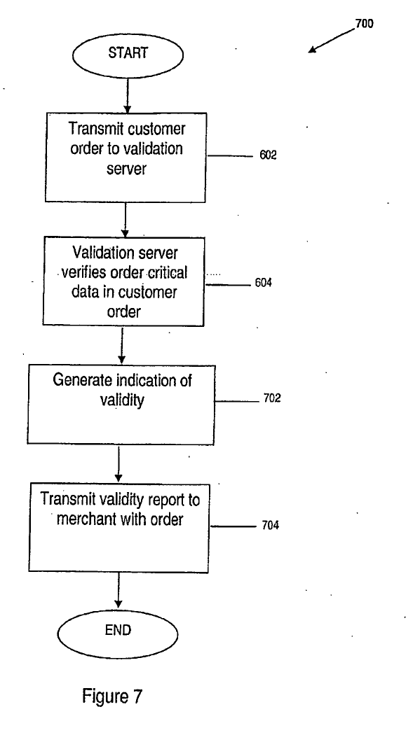

FIG. 7 shows a flowchart of an alternative method 700 of identifying altered order critical data, wherein the initial steps 602, 604 of transmitting the customer order to a validation server, and verifying the order critical data in the customer order are carried out as in method 600 illustrated in FIG. 6. At step 702 an indication of validity is generated based on the outcome of the verification step 604. However, rather than rejecting invalid orders, instead a validity report is generated at step 704, which may be transmitted to a relevant merchant along with the customer order, thereby enabling the merchant to receive and review invalid orders as well as valid orders.

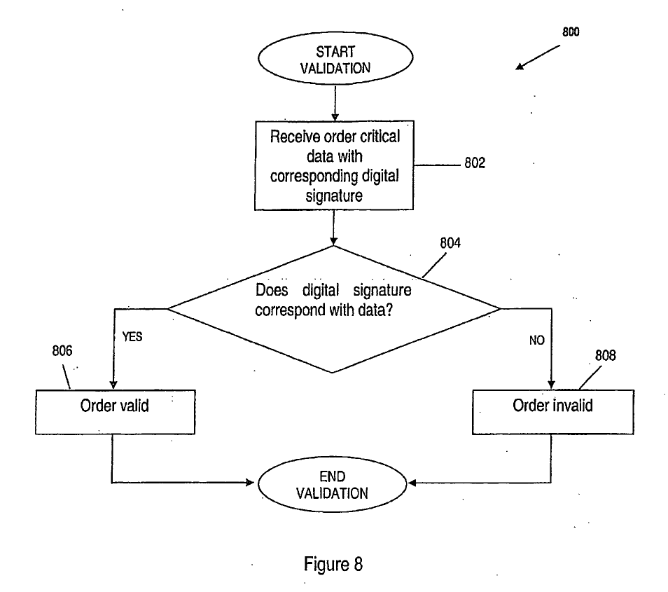

In FIGS. 8 to 12 there are depicted flowcharts of various methods for carrying out the validation step 604 in accordance with preferred embodiments of the invention.

A validation method 800 is depicted in the flowchart of FIG. 8 in which, at step 802, order critical data is received that includes a corresponding digital signature. At step 804, the validation server determines whether or not the digital signature corresponds with the order critical data. A matching digital signature indicates that the order critical data has not been altered, and at step 806 an indication of validity of the order may be generated. In the case of a mismatch between the digital signature and the order critical data, the validation server determines that the order is invalid and generates a corresponding indication at step 808.

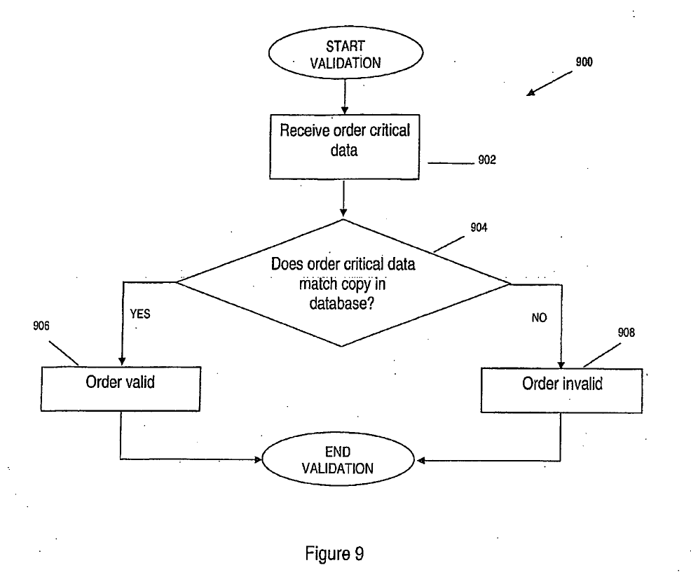

FIG. 9 shows a flowchart 900 of another method of validating order critical data. At step 902, the order critical data is received by the validation server. At step 904, the validation server looks up corresponding product details and order critical data in an associated database, and compares with the received order critical data. In the event of a match, an indication that an order is valid is generated at step 906. If a mismatch occurs, an indication that the order is invalid is generated at step 908.

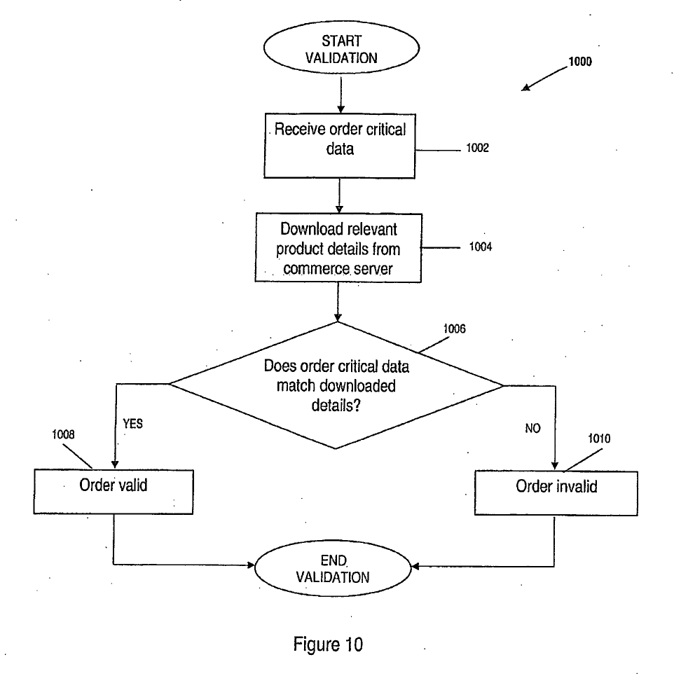

FIG. 10 shows a flowchart of yet another validation method 1000 according to an embodiment the invention. At step 1002 order critical data is received by the validation server, which then downloads corresponding relevant product details from a commerce server at step 1004. At step 1006 the received order critical data is compared with the corresponding data in the downloaded product details. If a match is found, an indication of validity of the order is generated at step 1008, whereas if a mismatch is detected an indication of invalidity is generated at step 1010.

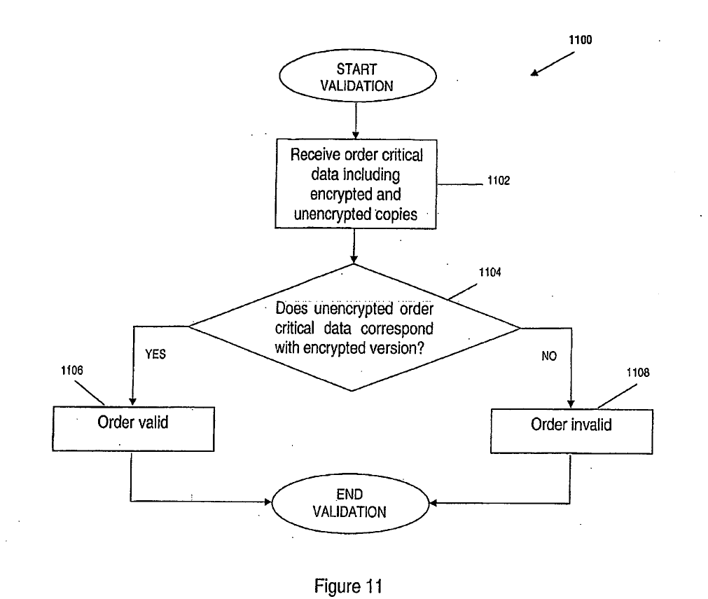

Still a further method 1100 of validating order critical data is depicted in the flowchart shown in FIG. 11. At step 1102 the validation server receives order critical data that includes both an encrypted copy and unencrypted copy of the data. At step 1104 the validation server determines whether the encrypted order critical data corresponds with the unencrypted order critical data. In the case of a match, an indication of validity of the order is generated at step 1106. However, if a mismatch is found and indication of invalidity is generated at step 1108.

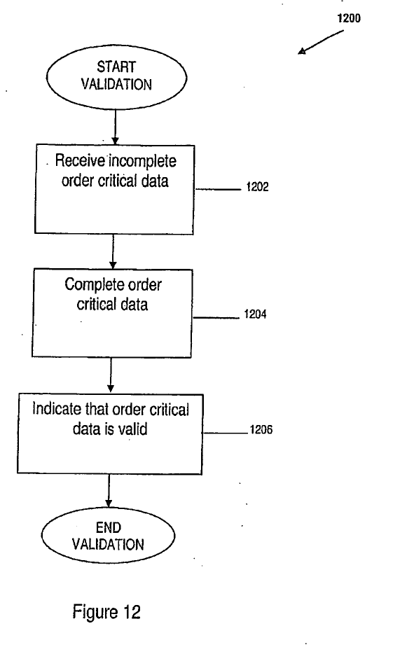

FIG. 12 depicts yet another method 1200 of validation of order critical data according to a further embodiment of the invention. At step 1202, the validation server receives incomplete order critical data. At step 1204 the validation server completes the order critical data with valid data obtained, for example, from an associated local database, or downloaded from a relevant commerce server. At step 1206, an indication that the order critical data is valid may thereby be generated.

From the foregoing description, it will be readily apparent to those skilled in the art that many variations of the system and method for identifying fraudulently altered orders are possible in accordance with the invention, which is not to be limited to the embodiments described. For example, it will be understood that although the preferred embodiments have been described with reference to an online commerce server, the invention can be readily adapted to embodiments in which the electronic shop is contained on a computer readable medium, such as a CDROM. The computer readable medium may thus be distributed to customers, who are able to make product selections and generate orders without the need to connect to a remote commerce server.

1.-39. (canceled)

40. A method of identifying altered order critical data in a system for conducting electronic commerce over a public data network in which orders are placed by a customer using a computer, the method comprising the steps of:
transmitting an electronic order of the customer over the public data network from the customer computer to a validation server that validates order critical data included in the order, the validation server executing the steps of:
verifying said order critical data; and
generating an indication of the validity or otherwise of the order critical data.

41. The method of claim 40 wherein the indication of whether the order critical data is valid or otherwise comprises an indication that the order critical data has been altered in the event that the order critical data is invalid.

42. The method of claim 40 further comprising the step of the validation server transmitting the electronic order to at least one relevant merchant for fulfilment in the event that the order critical data is valid.

43. The method of claim 40 further comprising the step of the validation server rejecting the electronic order in the event that the order critical data is invalid.

44. The method of claim 40 further comprising the validation server executing the steps of:
generating a report including information indicating whether or not said order critical data is valid; and
transmitting the report to one or more relevant merchants receiving the electronic order thus enabling said merchants to identify if order critical data in the electronic order is valid.

45. The method of claim 40 further comprising the steps of:
providing a commerce server for serving product details;
the customer downloading product details from the commerce server to the customer computer over the public data network; and
generating the electronic order using the product details downloaded from the commerce server.

46. The method of claim 45 wherein said product details comprises the order critical data and wherein the order critical data is digitally signed with a secret key, and wherein:
the step of transmitting comprises transmitting the digital signature along with the electronic order; and
the step of verifying comprises the validation server verifying that the digital signature corresponds with the order critical data.

47. The method of claim 45 wherein the order critical data is duplicated in said product details, which comprise a first copy of the order critical data in unencrypted form and a second copy encrypted using a secret key, and wherein:
the step of transmitting includes transmitting the encrypted copy of the order critical data along with the electronic order; and
the step of verifying includes the validation server verifying that the encrypted data corresponds with the unencrypted order critical data in the electronic order.

48. A validation server for identifying altered order critical data in a system for conducting electronic commerce over a public data network in which orders are placed by a customer using a computer, the validation server comprising:
receiving means for receiving an electronic order of the customer transmitted over the public data network from the customer computer, said electronic order comprising order critical data;
verifying means for verifying said order critical data; and
indicating means for generating an indication of whether the order critical data is valid or otherwise, to enable altered order critical data to he identified.

49. The validation server of claim 48 further including a report generating means for generating, on the basis of the indication generated by said indicating means, a report comprising information indicating whether or not said order critical data in the electronic order is valid.

50. The validation server of claim 48 wherein the receiving means is adapted to receive a digital signature along with the electronic order, the digital signature being the result of digitally signing the order critical data with a secret key, and the verifying means comprises means for verifying that the digital signature corresponds with the order critical data.

51. The validation server of claim 48 wherein the receiving means is adapted to receive duplicated order critical data comprising a first copy in unencrypted form and a second copy encrypted using a secret key, and the verifying means comprises means for verifying that the encrypted data corresponds with the unencrypted order critical data in the electronic order.

52. A method of operating a validation server, in a system for conducting electronic commerce over a public data network in which orders are placed by a customer using a computer, the method comprising the steps of:
receiving from the customer computer over the public data network an electronic order of the customer, said electronic order comprising order critical data;
verifying said order critical data; and
generating an indication of the validity or otherwise of the order critical data.

53. The method of claim 52 wherein the electronic order comprises product details obtained from a commerce server, said product details being digitally signed with a secret key, and wherein the step of verifying comprises verifying that the digital signature corresponds with the order critical data.

54. The method of claim 52 wherein the electronic order comprises product details obtained from a commerce server, said product details comprising a first copy of said order critical data in unencrypted form, and a second copy of said order critical data encrypted using a secret key, and wherein the step of verifying comprises verifying that the encrypted data corresponds with the unencrypted order critical data in the electronic order.

55. A method of a customer placing an order in a system for conducting electronic commerce over a public data network whereby alterations to order critical data are identified, the method comprising the steps of:
generating an electronic order including order critical data; and
transmitting the electronic order over the public data network to a validation server that verifies said order critical data, and generates an indication of the validity or otherwise of the order critical data.

56. The method of claim 55 wherein the step of generating comprises:
downloading relevant product details from a commerce server over the public data network; and
generating the electronic order using the product details downloaded from said commerce server.

57. The method of claim 56 wherein said product details comprise the order critical data and the order critical data is digitally signed with a secret key, and the step of transmitting comprises transmitting the digital signature along with the electronic order, whereby the validation server verifies the order critical data by verifying that the digital signature corresponds with the order critical data.

58. The method of claim 56 wherein the product details comprise a first copy of the order critical data in unencrypted form and a second copy of the order critical data encrypted using a secret key, and the step of transmitting comprises transmitting the encrypted copy of the order critical data along with the electronic order, whereby the validation server verifies the order critical data by verifying that the encrypted data corresponds with the unencrypted order critical data in the electronic order.

59. A client-side software product for use in a customer computer in a system for conducting electronic commerce over a public data network where orders are placed by a customer using a computer, the client-side software product comprising:
computer instruction code embodied on a tangible computer-readable medium for generating an electronic order of the customer including order critical data; and
computer instruction code embodied on said computer-readable medium for effecting transmission of the electronic order over the public data network from the customer computer to a validation server that verifies said order critical data and generates an indication of the validity or otherwise of the order critical data.
